(19) United States
(12) Patent Application Publication
(10) Pub. No.: US 2026/0048939 A1
(43) Pub. Date: Feb. 19, 2026

(54) LOAD HANDLING SHUTTLE AND METHOD THEREOF

(71) Applicant: Intelligrated Headquarters, LLC, Mason, OH (US)

(72) Inventors: Benjamin Russ, Cincinnati, OH (US); Jarl Sebastian, Liberty Township, OH (US); Justin Brouk, Cincinnati, OH (US); Felipe De Almeida, Mason, OH (US)

(21) Appl. No.: 18/809,120

(22) Filed: Aug. 19, 2024

(51) Int. Cl. B65G 1/04

(52) U.S. Cl. CPC B65G 1/0492

(57) ABSTRACT

A load handling shuttle adapted to move forward and backward along an X-axis and a Y-axis on a track is disclosed. The shuttle comprises a shuttle body, a load handling device (LHD) having a first LHD arm and a second LHD arm extendable back and forth in the Y-axis direction. The LHD comprising a first LHD motor and a second LHD motor configured to propel the first LHD arm and the second LHD arm in the Y-axis direction. Further, the LHD comprises a first LHD motor encoder and a second LHD motor encoder configured to determine one or more feedback parameters of the first LHD motor and the second LHD motor, respectively. Further, at least one inertial measurement unit (IMU) configured to determine linear acceleration of the LHD in the Y-axis direction. Further, at least one processor predicts a current state of the LHD.

### TECHNOLOGICAL FIELD

Example embodiments of the present disclosure relate generally to a shuttle system, and more particularly relates to a load handling shuttle adapted to move forward and backward along an X-axis.

### BACKGROUND

Automated Storage and Retrieval System (ASRS) is a sophisticated warehouse automation technology employing robotic shuttles to store and retrieve items efficiently. ASRS replaces manual labor with automated processes, enhancing storage capacity, and retrieval speed while minimizing errors. ASRS is crucial in industries requiring rapid access to inventory, such as manufacturing, distribution, and logistics. Further, ASRS optimizes space utilization by stacking items vertically and utilizing robotic shuttles to transport goods to designated pick-up points. ASRS technology continues to evolve, improving operational efficiency, and scalability in modern warehouses. An automatic robotic device i.e., shuttle is generally used in the system. The shuttle operates autonomously, moving along designated tracks or aisles to retrieve items stored in racks or shelves. Such accurate positioning of the shuttle is crucial in ASRS to ensure precise retrieval and placement of items, minimizing errors and optimizing operational efficiency.

The inventors have identified numerous areas of improvement in the existing technologies and processes, which are the subjects of embodiments described herein. Through applied effort, ingenuity, and innovation, many of these deficiencies, challenges, and problems have been solved by developing solutions that are included in embodiments of the present disclosure, some examples of which are described in detail herein.

### BRIEF SUMMARY

The following presents a simplified summary to provide a basic understanding of some aspects of the present disclosure. This summary is not an extensive overview and is intended to neither identify key or critical elements nor delineate the scope of such elements. Its purpose is to present some concepts of the described features in a simplified form as a prelude to the more detailed description that is presented later.

In an example embodiment, a load handling shuttle adapted to move forward and backward along an X-axis on a track is disclosed. The shuttle comprises a shuttle body and a load handling device (LHD) coupled to the shuttle body and having a first LHD arm and a second LHD arm extendable back and forth in the Y-axis direction. The LHD comprises a first LHD motor and a second LHD motor configured to independently actuate the first LHD arm and the second LHD arm in the Y-axis direction, and a first LHD motor encoder and a second LHD motor encoder configured to determine one or more feedback parameters of the first LHD motor and the second LHD motor, respectively. The shuttle further comprises at least one inertial measurement unit (IMU) coupled to the LHD, where the at least one IMU is configured to determine linear acceleration of the LHD in the Y-axis direction. Thereafter, the shuttle comprises at least one processor communicatively coupled to the at least one IMU, the first LHD motor encoder and the second LHD motor encoder. The at least one processor is configured to fuse the linear acceleration of the LHD in the Y-axis direction with the one or more feedback parameters of the first LHD motor and the second LHD motor to predict a current position of the LHD.

In some embodiments, the at least one processor is further configured to repeatedly predict the current state of the LHD at a time step, based on the one or more feedback parameters from an immediately preceding time step to determine a predicted state estimate; sample the measurement data from the at least one IMU, first LHD motor encoder, and the second LHD motor encoder, to determine an updated predicted state; compare the updated predicted state to a desired LHD state; and control operation of the first LHD motor and the second LHD motor to deploy the LHD according to the desired LHD state.

In some embodiments, the shuttle further comprises a plurality of wheels mounted to the shuttle body and adapted to contact the track; at least one drive motor to propel the shuttle along the track; at least one drive motor encoder configured to determine the one or more feedback parameters of the drive motor.

In some embodiments, the at least one IMU is configured to determine linear acceleration of the shuttle body in the X-axis direction.

In some embodiments, the at least one processor is communicatively coupled to the at least one IMU, the at least one drive motor and the drive motor encoder, where the at least one processor is configured to fuse the linear acceleration of the shuttle body in the X-axis direction with the one or more feedback parameters of the at least one drive motor to predict a current state of the shuttle body in the X-axis direction.

In some embodiments, the at least one processor is further configured to repeatedly predict the current state of the shuttle body at a time step, based on the one or more feedback parameters from an immediately preceding time step to determine a predicted state estimate; sample a measurement data from the at least one IMU, and the drive motor encoder, to determine an updated predicted state; compare the updated predicted state to a desired shuttle body state; and control operation of the drive motor to propel the shuttle body according to the desired shuttle body state.

In some embodiments, the measurement data comprise position, velocity, and acceleration of the LHD or the shuttle body corresponding to the updated predicted state and derived from the at least one IMU, first LHD motor encoders and the second LHD motor.

In some embodiments, the at least one IMU comprises at least one of a mono-axial accelerometer, a tri-axial accelerometer, a magnetometer, or a gyroscope.

In some embodiments, the one or more feedback parameters comprise at least one of position, speed, acceleration, and direction of the first LHD motor, the second LHD motor and the at least one drive motor derived from the first LHD motor encoder and the second LHD motor encoder from the immediately preceding time step. In some embodiments, the state estimation of the shuttle or the LHD accounts for process noise corrected using a correction factor, wherein the correction factor corresponds to a numerical value configured to update the current state.

In another example embodiment, a method of sensing state of the load handling shuttle is disclosed. The method comprises the steps of determining, via a first load handling device (LHD) motor encoder and a second LHD motor encoder, one or more feedback parameters of a first LHD motor and a second LHD motor respectively, wherein the first LHD motor and the second LHD motor are configured to actuate a first LHD arm and a second LHD arm of a LHD coupled to a shuttle body of a shuttle in a Y-axis direction; determining, via at least one IMU coupled to the LHD, linear acceleration of the LHD in the Y-axis direction; and fusing, via at least one processor communicatively coupled to the at least one IMU, the first LHD motor encoder and the second LHD motor encoder, the linear acceleration of the LHD in the Y-axis direction with the one or more feedback parameters of the first LHD motor and the second LHD motor to predict a current state of the LHD.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 illustrates a top view of a shuttle in accordance with an example embodiment of the present disclosure;

FIG. 2 illustrates a side view of a load handling device (LHD) in a stowed state in accordance with an example embodiment of the present disclosure;

FIGS. 3A-3C illustrate equations for state estimation of the shuttle in accordance with an example embodiment of the present disclosure;

FIG. 4 illustrates a top view of the LHD in a deployed position in accordance with an example embodiment of the present disclosure;

FIG. 5 illustrates a illustrates block diagram depicting coupling of the at least one IMU, the drive motor encoder, the first LHD motor encoder and the second LHD motor encoder of the shuttle in accordance with an example embodiment of the present disclosure;

FIG. 6 illustrates a block diagram of a method of operating the shuttle in accordance with an example embodiment of the present disclosure; and

FIG. 7 illustrates a flowchart showing a method in accordance with an example embodiment of the present disclosure.

### DETAILED DESCRIPTION

Some embodiments will now be described more fully hereinafter with reference to the accompanying drawings, in which some, but not all, embodiments of the present disclosure are shown. Indeed, various embodiments may be embodied in many different forms and should not be construed as limited to the embodiments set forth herein; rather, these embodiments are provided so that this disclosure will satisfy applicable legal requirements.

The components illustrated in the figures represent components that may or may not be present in various embodiments of the present disclosure described herein such that embodiments may include fewer or more components than those shown in the figures while not departing from the scope of the present disclosure. Some components may be omitted from one or more figures or shown in dashed line for visibility of the underlying components.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in various embodiments,” “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments or it may be excluded.

The present disclosure provides various embodiments of a load handling shuttle adapted to move forward and backward along an X-axis on a track. Embodiments may further comprise a shuttle body, a load handling device (LHD) coupled to the shuttle body and having a first LHD arm and a second LHD arm extendable back and forth in the Y-axis direction. Embodiments may further comprise a first LHD motor and a second LHD motor configured to independently propel the first LHD arm and the second LHD arm in the Y-axis direction. Embodiments may further comprise a first LHD motor encoder and a second LHD motor encoder configured to determine one or more feedback parameters of the first LHD motor and the second LHD motor, respectively. Embodiments may further comprise at least one inertial measurement unit (IMU) coupled to the LHD, where the at least one IMU are configured to determine linear acceleration of the LHD in the Y-axis direction. Embodiments may further comprise at least one processor communicatively coupled to the at least one IMU, the first LHD motor encoder and the second LHD motor encoder, where the at least one processor is configured to fuse the linear acceleration of the LHD in the Y-axis direction with the one or more feedback parameters of the first LHD motor and the second LHD motor to predict a current state of the LHD.

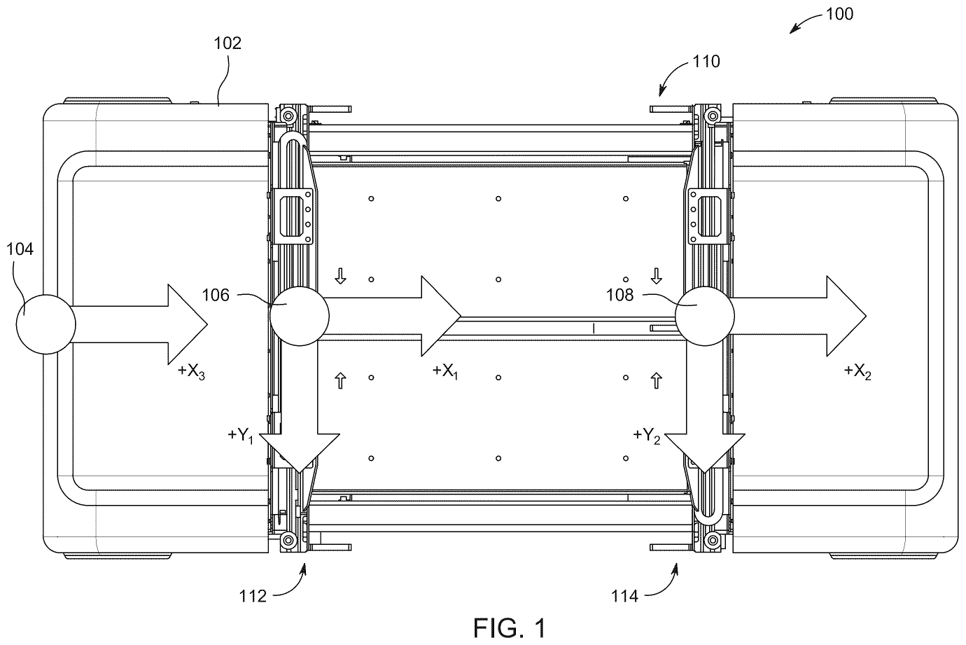

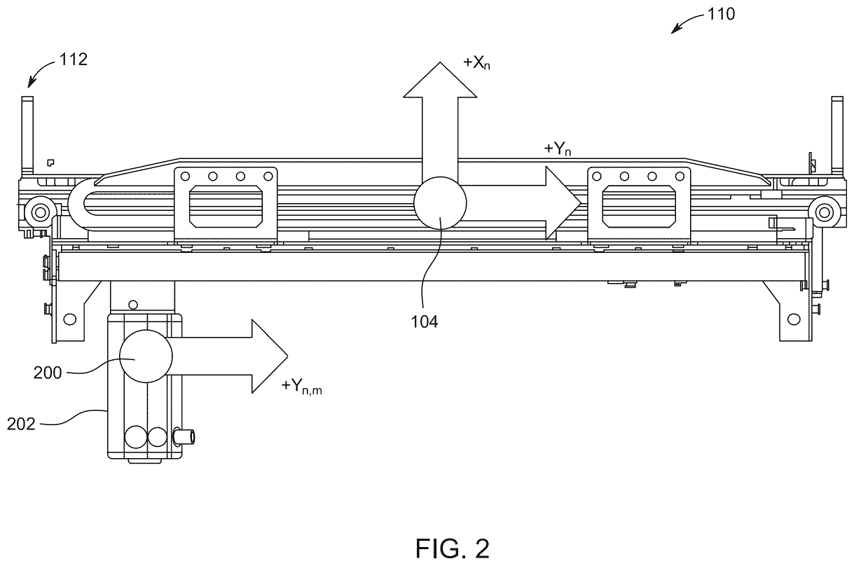

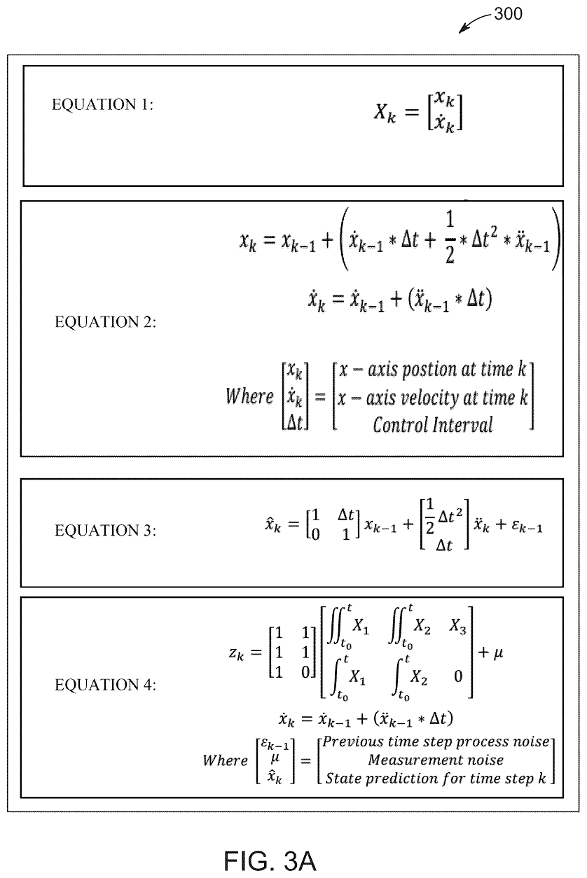

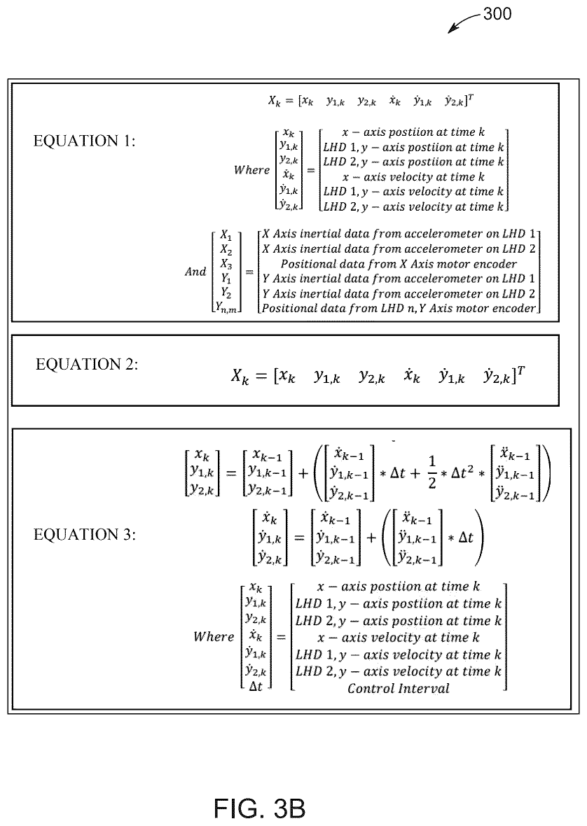

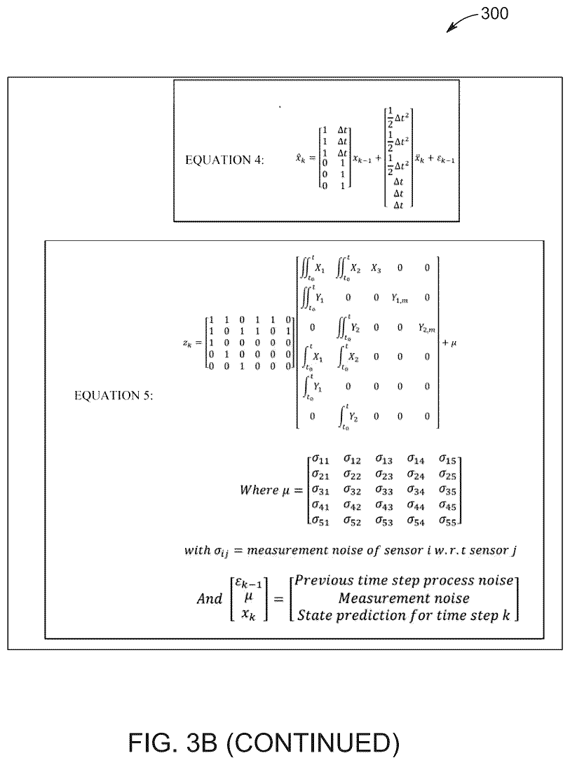

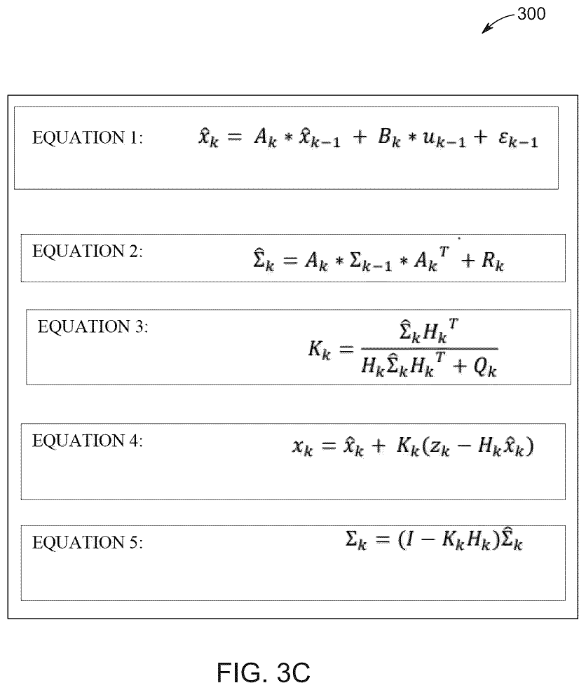

FIG. 1 illustrates a top view of a shuttle 100, in accordance with an example embodiment of the present disclosure. FIG. 2 illustrates a side view of a load handling device (LHD) 110 in a stowed state, in accordance with an example embodiment of the present disclosure. FIGS. 3A-3C illustrate equations 300 for state estimation of the shuttle in accordance with an example embodiment of the present disclosure.

In some embodiments, the shuttle 100 may comprise a shuttle body 102 and a plurality of wheels (not shown) attached underneath the shuttle body 102. In some embodiments, the wheels are configured to rotate over a track (not shown) to enable movement of the shuttle body 102. In some embodiments, the track may be laid within an automated storage and retrieval facility. In some embodiments, the automated storage and retrieval facility may correspond at least one of a warehouse, a factory, an industrial plant, etc. In some embodiments, the shuttle body 102 may be coupled with a power source (not shown). In some embodiments, the power source may be configured to supply a predefined amount of power to the shuttle 100.

In some embodiments, the shuttle body 102 may be adapted to move along a rail or the track. In an example, the shuttle body 102 may be designed to navigate around one or more storage aisles while moving along the track. In an example, the storage aisles may be adapted to store goods in a storage facility. The shuttle body 102 may further comprise the plurality of wheels adapted to contact the track and enable movement of the shuttle 100 along an X-axis on the track. In some embodiments, the plurality of wheels may be adapted to navigate accurately along the track. In some embodiments, the plurality of wheels may be mounted to the shuttle body 102 by means of an axle (not shown). In some embodiments, the axle may be a central shaft or rod that remains integrated and rotates with the plurality of wheels.

The shuttle 100 may further comprise at least one drive motor (not shown) coupled to the plurality of wheels, at least one drive motor encoder 104 coupled to the at least one drive motor, at least one inertial measurement unit (IMU), the LHD 110, and at least one processor (not shown). In some embodiments, the at least one drive motor may be configured to drive one or more of the plurality of wheels in a plurality of direction to enable maneuvering of the shuttle 100 within the facility. In some embodiments, the at least one drive motor may be electrically powered and generate a mechanical output towards the axle. In an example, the electrical output may correspond to a way of transmitting rotational force generated by the at least one drive motor towards the plurality of wheels.

In some embodiments, the at least one drive motor may be coupled with the at least one drive motor encoder 104. The at least one drive motor encoder 104 may detect rotation of the at least one drive motor by utilizing one or more sensors that monitor the movement of the axle. In some embodiments, the one or more sensors may correspond to at least optical sensor, magnetic sensor, inductive sensor, capacitive sensor or resistive sensor. Further, the at least one drive motor encoder 104 may be mounted or connected to the axle and configured to generate electrical signals based on changes in axle state or corresponding markings on an encoder disk (not shown). In some embodiments, the encoder disk may be an incremental encoder disk or absolute encoder disk capable of determining the axle's angular position and speed with respect to a reference point or starting point. In some embodiments, the at least one drive motor encoder 104 with the encoder disk, may provide unique digital codes for determining precise axle position.

In some embodiments, when the shuttle 100 may move along the track, the plurality of wheels rotate due to rotation of the axle. The rotation of the axle may be controlled by the at least one drive motor. Further, the at least one drive motor encoder 104 may detect the rotation of the at least one drive motor by determining position of the axle. Further, based on the rotation of the at least one drive motor, the at least one drive motor encoder 104 may determine position (X₃) of the shuttle 100 on the track in the X-axis direction (as shown in FIG. 1 as X₃). In some embodiments, the at least one drive motor encoder 104 may determine one or more feedback parameters of the at least one drive motor to determine position (X₃) of the shuttle 100. In an example, the one or more feedback parameters may correlate to the movement of the shuttle 100 at a preceding time step with respect to the time step wherein current state of the shuttle 100 may be determined. In some embodiments, the one or more feedback parameters may comprise at least one of position (X₃), speed, and direction of the shuttle 100 (FIG. 1).

In some embodiments, the shuttle 100 may also comprise at least one IMU. The at least one IMU may be configured to determine linear acceleration of the shuttle 100 along the track in the X-axis direction. In some embodiments, the at least one IMU may comprise at least one of a mono-axial accelerometer, a tri-axial accelerometer, a magnetometer, or a gyroscope. In some embodiments, the at least one IMU may include gyroscope to measure the rate of angular rotation of the shuttle 100 around different axes (X, Y, and Z). For the X-axis, the gyroscope within the at least one IMU may detect changes in rotational velocity. In some embodiments, by integrating a measurement data of the gyroscope over time, the at least one IMU may be configured to determine angular acceleration along with the linear acceleration. In some embodiments, the mono-axial accelerometer or the tri-axial accelerometer may measure changes in velocity of the shuttle 100 along different axes (X, Y and Z). Specifically, for the X-axis, the mono-axial accelerometer may detect linear acceleration, which indicates change in velocity of the shuttle 100 in X-axis direction as the measurement data of the accelerometer. The measurement data may include changes in speed (magnitude of velocity) and changes in direction (vector direction of velocity) of the shuttle 100.

In another example, the at least one IMU may fuse the measurement data from the mono-axial accelerometer, tri-axial accelerometer and gyroscope to determine linear acceleration of the shuttle 100 accurately. The gyroscopic measurement data may provide angular rate, and the accelerometer measurement data may provide linear acceleration. In some embodiments, by integrating the measurement data over time using algorithms such as Kalman filters or sensor fusion techniques, the at least one IMU may determine linear acceleration (for translational motion) of the shuttle 100 along the X-axis.

In some embodiments, the at least one IMU may further comprise a magnetometer. The magnetometer may be configured to detect and measures the strength and direction of the Earth's magnetic field. The measurement data from the magnetometer may determine the orientation or heading of the shuttle 100 relative to magnetic north. In an example embodiment, when the measurement data of the magnetometer may be fused with the measurement data of the accelerometer and gyroscope, the magnetometer may determine orientation of the shuttle 100 with respect to the Earth's magnetic field. In an example embodiment, the magnetometer may be fused with the at least one IMU such that the shuttle 100 may be configured to move along the track including turns and changes in direction of the shuttle 100.

In some embodiments, the shuttle 100 may comprise at one processor communicatively coupled to the at least one IMU, and the at least one drive motor encoder 104. The at least one processor may be configured to fuse the one or more feedback parameters from the at least one drive motor encoder 104 with the linear acceleration of the shuttle body 102 in the X-axis direction to predict a current state of the shuttle body 102 in the X-axis direction. In some embodiments, the at least one processor may be configured to predict the current state of the shuttle 100 along the X-axis at a time step based on position data from an immediately preceding time step to determine a predicted state estimate. In an example embodiment, the at least one processor may receive measurement data from the at least one drive motor encoder 104, wherein the at least one drive motor encoder 104 may be configured to record the state data of the shuttle 100 respectively as the shuttle 100 moves along the track.

In some embodiments, during the movement of the shuttle 100 along the track, the at least one drive motor encoder 104 may repetitively determine the rotation of the at least one drive motor and record the state data as reference coordinates of the shuttle 100. Based on these reference coordinates, the at least one processor may predict the current state (X₃) of the shuttle 100 along the X-axis. The predicted current state (may be dependent on the reference coordinates of the shuttle 100 from an immediately preceding time step. In an example embodiment, the at least one processor may predict the current state (X₃) at the time step ‘k’ on the basis of the reference coordinates i.e., state data of the shuttle 100 at the time step ‘k−1’.

In an example, a mono-axial accelerometer is mounted on the LHD 110. The state of the shuttle 100 is defined by equation 1 depicting the state of the shuttle. (as shown in FIG. 3A). Further, the kinematic motion of the shuttle 100 is further defined as in equation 2. Further, via using the at least one processor, the state prediction of current time is determined as shown as equation 3. In some embodiments, based on the determined state prediction, the measurement of the state of the shuttle 100 is found as in equation 4.

In another example, if the tri-axial accelerometer may be coupled with the moving LHD 110 to determine linear and angular acceleration of the LHD 110, in that case, the state of the shuttle 100 is defined by equation 1 (as shown in FIG. 3B). In some embodiments, given the tri-axial accelerometer is mounted to the moving LHD 110, the shuttle sate is defined by the equation 2 and the kinematic motion of the shuttle 100 is further defined as in equation 3. Further, via using the at least one processor, the state prediction of current time is determined as shown as equation 4. In some embodiments, based on the determined state prediction, the measurement of the state of the shuttle 100 is found as in equation 5.

In the further embodiments, the at least one processor may be configured to repeatedly predict current state of the shuttle body 102 at the time step, based on the one or more feedback parameters from an immediately preceding time step. Further, the at least one processor may be configured to sample the measurement data from the at least one IMU and the at least one drive motor encoder 104, to determine an updated predicted state. In some embodiments, the at least one processor may further be configured to compare the updated predicted state to a desired shuttle body state and control operation of the at least one drive motor to propel the shuttle body 102 according to the desired shuttle body state.

In an example embodiment, the kinematic equations may employ mathematical formulas that relate to the shuttle 100 motion without considering the forces causing that motion. The kinematic equations may account for variables like initial state, velocity, acceleration and time. By continuously updating these calculations based on the measurement data from the at least one IMU, the at least one processor may determine the updated predicted state. In an example embodiment, the at least one processor may transmit the updated predicted state data towards the at least one drive motor encoder 104 which drives the at least one drive motor. The at least one drive motor may further drive the wheels that move to propel the shuttle 100 to achieve the updated predicted state.

In an example, by integrating the measurement data over time using algorithms such as Kalman filters or sensor fusion techniques, the at least one IMU may determine linear acceleration (for translational motion) of the shuttle 100 along the X-axis. In an embodiment, Kalman filter and the sensor fusion techniques may comprise an equation 1 (FIG. 3C) for determining a predicted state estimate wherein the posterior state estimate (\hat{X}ₖ) at time ‘k’ may be dependent on state transition matrix (Aₖ), posterior state estimate value at time ‘k−1’, control transition matrix (Bₖ) (as shown in equation 1 of FIG. 3C). The techniques may further comprise a priori error covariance matrix dependent on Kalman Gain matrix (Kₖ) and the measurement transformation matrix (Hₖ) as shown in equation 2 of FIG. 3C). furthermore, the techniques may involve Kalman Gain as presented in equation 3 of FIG. 3C and a posteriori estimation of equation 4 (FIG. 3C). The corrected state of the shuttle 100 and LHD 110 may be derived using the error covariance matrix (equation 5 of FIG. 3C). In another example, the algorithms such as Extended Kalman Filter, Unscented Kalman Filter, with and without correspondence may also be used for integrating the measurement data over time.

In some embodiments, the shuttle 100 may further comprise a pair of LHD arms and the LHD 110, as shown in a stowed state in FIG. 2. The stowed state may correlate to non-extended state of the LHD 110. In an example embodiment the LHD 110 may be mounted on top portion of the shuttle 100 by means of a first LHD arm 112 and a second LHD arm 114. The first LHD arm 112 and the second LHD arm 114 may be telescopic attachments. The LHD arms may be configured to extend back and forth in a Y-axis direction to enable the LHD 110 to grip, lift or move one or more goods or parcels. In the stowed state as shown in FIG. 2, the first LHD arm 112 and the second LHD arm 114 may be in a non-extended state.

In some embodiments, the LHD 110 may further comprise a pair of LHD motor encoders i.e., a first LHD motor encoder 200 for the first LHD arm 112 and a second LHD motor encoder (not shown) for the second LHD arm 114. In some embodiments, the LHD 110 may further comprise the at least one IMU. In an example, the LHD 110 may further comprise the first IMU 106 mounted on the first LHD arm 112 and a second IMU 108 mounted on the second LHD arm 114, as shown in FIG. 1. The first LHD motor encoder and the second LHD motor encoder may be configured to determine rotation of the first LHD motor 202 and the second LHD motor when the first LHD arm 112 and the second LHD arm 114 may be configured to retract back and forth within the Y-axis direction. In an example, the shuttle 100 may comprise a common actuator to extend the first LHD arm 112 and the second LHD arm 114 back and forth. Herein, the first LHD arm 112 and the second LHD arm 114 may be extend back and forth in single degree of freedom. The common actuator may be coupled to at least one encoder to determine position of the first LHD arm 112 and the second LHD arm 114 and store one or more feedback parameters related to the determined position.

In another example, the first LHD arm 112 may comprise a first LHD motor 202 along with the first LHD motor encoder 200, and the second LHD arm 114 may comprise the second LHD motor along with the second LHD motor encoder (not shown). Herein, the first LHD arm 112 and the second LHD arm 114 may extend back and forth in independent degree of freedom.

In some embodiments, at least one IMU, may determine the linear acceleration of the first LHD arm 112 and second LHD arm 114. In an example, the at least one IMU may determine the linear acceleration when the first LHD arm 112 and the second LHD arm 114 may be extend back and forth in single degree of freedom. The at least one IMU may be coupled to the first LHD arm 112. The at least one IMU may function in correlation with an alignment indicator of the second LHD arm 114.

In another example, wherein the first IMU 106 may determine the linear acceleration of the first LHD arm 112 and the second IMU 108 may determine linear acceleration of the second LHD arm 114, wherein the first LHD arm 112 and the second LHD arm 114 may extend in independent degree of freedom. Further, the first motor encoder 200 (as shown Y_{n,m}), may define the nth degree of freedom with respect to the first LHD motor 202. In an example, at least one IMU may comprise at least one of a mono-axial accelerometer, a tri-axial accelerometer, a magnetometer, or a gyroscope. In an example, the at least one IMU may determine linear acceleration of the first LHD arm as well as the shuttle 100. In an example, the at least one IMU may be configured to determine linear acceleration of the first LHD arm 112 and the second LHD arm 114, wherein the LHD arm 112 and the second LHD arm 114 may be coupled together and driven by the at least one of the first LHD motor encoder 200 or the second LHD motor encoder (not shown). In an example, the fusion of measurement data from the first LHD motor encoder 200, the second LHD motor encoder (not shown), the at least one IMU may determine state of the LHD 110 in Y-axis direction, as explained previously in FIG. 1.

In some embodiments, the at least one processor may be communicatively coupled to the first LHD motor encoder 200, the second LHD motor encoder (not shown) and at least one IMU of the LHD 110. In an example embodiment, the at least one IMU may be common source of measurement data (Y₁, Y₂) for the LHD 110 in Y-axis direction and measurement data (X₁, X₂) of the shuttle 100 in X-axis direction. The measurement data may correspond to current position of the LHD 110 and the X-axis

In some embodiments, the at least one processor may be configured to repeatedly predict the current state of the LHD 110 at a time step, based on the one or more feedback parameters from an immediately preceding time step to determine a predicted state estimate. Further, the at least one processor may be configured to sample a measurement data from the at least one IMU first LHD motor encoder 200, and the second LHD motor encoder, to determine an updated predicted state. Further, the at least one processor may be configured to compare the updated predicted state to a desired LHD state. Further the at least one processor may be configured to control operation of the first LHD motor 202 and the second LHD motor to deploy the LHD 110 according to the desired LHD state. In some embodiments, the updated prediction state may become the predicted state of the immediately preceding time step for an immediately succeeding time step.

In an example, the measurement data from the at least one IMU, the first LHD motor encoder 200 and the second LHD motor encoder includes position and velocity of the first LHD arm 112 and the second LHD arm 114. In an example, the position data (one or more feedback parameters) from the immediately preceding time step may correlate to position coordinates (Xₙ, Yₙ) of the LHD 110 at the time step ‘k−1’, while a predicted current state of the LHD 110 may be determined at the time step ‘k’. Further, the updated predicted state may correlate to the position data from the preceding time step ‘k’ while determining state of the LHD 110 at the immediately succeeding time may be ‘k+1’.

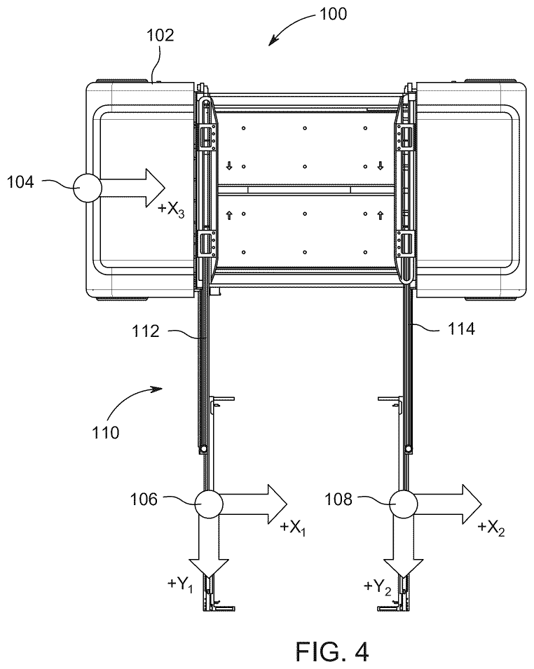

FIG. 4 illustrates a top view of the LHD 110 in a deployed state with respect to the shuttle 100, in accordance with an example embodiment of the present disclosure. FIG. 4 is described in conjunction with FIGS. 1-3B.

In some embodiments, the LHD 110 may be adapted to extend the first LHD arm 112 and the second LHD arm 114 towards the Y-axis direction, representing deployed state.

In some embodiments, the at least one processor may be configured to control operation of the first LHD motor 202 and the second LHD motor. The first LHD motor 202 and the second LHD motor may be coupled with the first LHD motor encoder 200 and the second LHD motor encoder. The first LHD motor encoder 200 and the second LHD motor encoder may be configured to detect rotation of the first LHD motor 202 and the second LHD motor. Further, the at least one processor may be coupled to the at least one IMU, configured to determine linear acceleration of the first LHD arm 112 and the second LHD arm 114.

In an example, the at least one processor may be configured to predict a current state (shown as Y1, Y2) of the LHD 110 along the Y-axis based on position data from an immediately preceding time step. The at least one processor may further sample the measurement data from the at least one IMU, the at least one drive motor encoder 104, the first LHD motor encoder 200 and the second LHD motor encoder (not shown) to determine an updated predicted state of the LHD 110. The at least one processor may also compare the updated predicted state to a desired LHD 110 state.

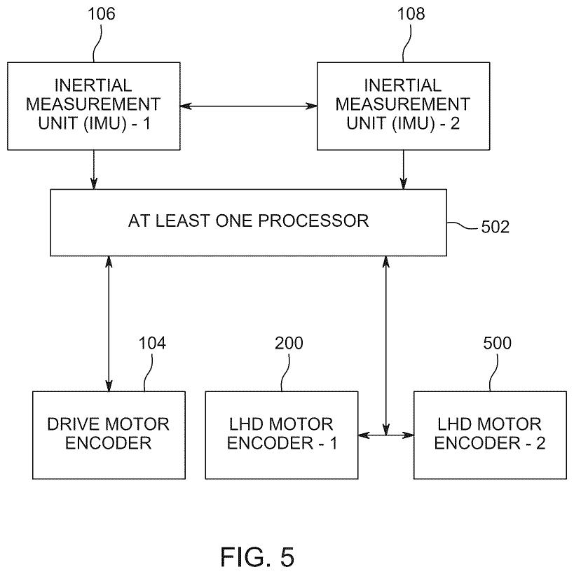

FIG. 5 illustrates block diagram depicting coupling of the at least one IMU, the drive motor encoder 104, the first LHD motor encoder 200 and the second LHD motor encoder 500 of the shuttle 100, in accordance with an example embodiment of the present disclosure. FIG. 5 is described in conjunction with FIGS. 1-4

In some embodiments, the shuttle 100 may comprise the at least one IMU. In an example, the first IMU 106 may be configured to determine linear acceleration of the shuttle 100 in the X-axis direction. In some embodiments, the shuttle 100 comprises the at least one drive motor encoder 104 configured to detect rotation of the at least one drive motor that propels the shuttle 100 to move on the track in the X-axis direction. In another example, the shuttle 100 may further comprise a second IMU 108 configured to determine linear acceleration of the LHD 110 in the Y-axis direction. In some embodiments, the LHD 110 may comprise a pair of LHD motor encoders i.e., the first LHD motor encoder 200 for the first LHD arm 112 and a second LHD motor encoder 500 for the second LHD arm 114.

In some embodiments, the LHD 110 may comprise at least one IMU. In an example, the LHD 110 may further comprise the first IMU 106 mounted on the first LHD arm 112 and the second IMU 108 mounted on the second LHD arm 114. The first LHD motor encoder 200 and the second LHD motor encoder 500 may be configured to determine rotation of the LHD motor when the first LHD arm 112 and the second LHD arm 114 retracts back and forth towards the Y-axis direction. The at least one IMU (example, the first IMU 106 and the second IMU 108), may determine linear acceleration of the second LHD arm.

In some embodiments, the at least one IMU, the at least one drive motor encoder 104, the first LHD motor encoder 200 and the second LHD motor encoder 500 may be coupled to the at least one processor 502. In an example embodiment, the at least one IMU, the at least one drive motor encoder 104, the second IMU 108, the first LHD motor encoder 200 and the second LHD motor encoder 500 may be configured to generate the measurement data corresponding to a predicted state estimate of the shuttle 100 and the LHD 110. In an example embodiment, the measurement data may correspond to the linear acceleration of the shuttle 100 and the LHD 110, and rotation of the at least one drive motor, the first LHD motor 202 and the second LHD motor.

In some embodiments, the at least one processor 502 may be configured to predict a current state of the shuttle 100 along the X-axis based on position data from an immediately preceding time step. In an example embodiment, the at least one processor 502 may receive measurement data from the at least one drive motor encoder 104, wherein the at least one drive motor encoder 104 may be configured to record the position data of the shuttle 100, as the shuttle 100 moves along the track. During the movement of the shuttle 100 motion along the track, the at least one drive motor encoder 104 may repetitively determine the rotation of the at least one drive motor and may record the position data as reference coordinates of the shuttle 100. Based on these reference coordinates, the at least one processor 502 may predict the current state of the shuttle 100 along the X-axis. The predicted current state may be dependent on the reference coordinates of the shuttle 100 from an immediately preceding time step to determine the predicted state estimate.

In some embodiments, the at least one processor may be configured to predict a current state of the LHD 110 along the Y-axis based on position data from an immediately preceding time step. In an example, the at least one processor may further sample the measurement data from the at least one IMU, the at least one drive motor encoder 104, the first LHD motor encoder 200 and the second LHD motor encoder 500 to determine an updated predicted state of the LHD 110. The at least one processor 502 may also compare the updated predicted state to a desired LHD 110 state and further control operation of the first LHD motor 202 and the second LHD motor to deploy the LHD arms according to the desired LHD 110 state in Y-axis direction. In some embodiments, the updated prediction state may become the state data for the immediately preceding time step for an immediately succeeding time step.

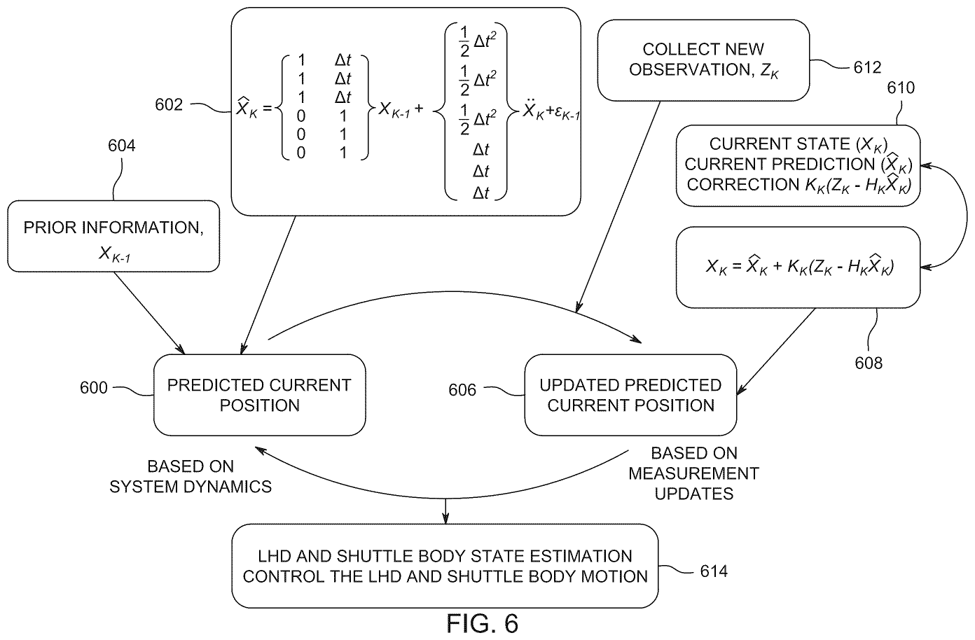

FIG. 6 illustrates a block diagram of a method of operating the shuttle 100, in accordance with an example embodiment of the present disclosure. FIG. 6 is described in conjunction with FIGS. 1-5.

In some embodiments, at operation 600, the at least one processor 502 may be configured to predict a current state of the shuttle 100 along the X-axis based on state data from an immediately preceding time step to obtain the predicted state. In an example embodiment, the state data may correspond to state coordinates (Xₖ, Yₖ) of the shuttle 100 and the LHD 110. In an example, the state coordinates (Xₖ, Yₖ) of the of the shuttle 100 and the LHD 110 may be determined on the basis of measurement data from the at least one IMU, the at least one drive motor encoder 104, the first LHD motor encoder 200 and the second LHD motor encoder 500. In an example embodiment, the at least one processor 502 is further configured to predict the current state of the shuttle 100 using one or more kinematic equations as shown by 602.

The one or more kinematic equations may be used to predict the current state of the shuttle 100. In an example embodiment, the kinematic equations may be used to predict the current state of the shuttle 100 at the time step ‘k’. In an example embodiment, the kinematic equations may employ mathematical formulas that relate to the shuttle 100 and the LHD 110 motion without considering the forces causing that motion. The kinematic equations may account for variables like initial state, velocity, acceleration and time. By continuously updating these calculations based on the measurement data from the at least one IMU, the second IMU 108, the at least one drive motor encoder 104, the first LHD motor encoder 200 and the second LHD motor encoder 500, the at least one processor 502 may sample the measurement data to determine the updated predicted state.

Further, the at least one processor 502 may use prior information (Xₖ₋₁) as shown by 604, to update the current state. In an example embodiment, the measurement data recorded at a preceding time step ‘k−1’ via the at least one of the at least one IMU, the at least one drive motor encoder 104, the first LHD motor encoder 200 and the second LHD motor encoder 500. The measurement data may correspond to the coordinates of the shuttle 100 and the LHD 110 at preceding time step denoted as (Xₖ₋₁, Yₖ₋₁).

At operation 606, the at least one processor 502 may sample the measurement data from the at least one IMU and the at least one drive motor encoder to determine an updated predicted state. In an example embodiment, the at least one processor 502 may be configured to continuously monitor change in the measurement data. In an example embodiment, the measurement data from the at least one IMU, the at least one drive motor encoder 104, the first LHD motor encoder 200 and the second LHD motor encoder (not shown) includes state and velocity of the first LHD arm, the second LHD arm or the shuttle 100. In an example embodiment, the measurement data from the at least one IMU and the at least one drive motor encoder 104 may correspond to change in state of the shuttle 100 in the X-axis direction. In another example embodiment, the measurement data from the at least one IMU, the first LHD motor encoder 200 and the second LHD motor encoder 500 may correspond to change in state of the LHD 110 in the Y-axis direction.

At operations 608 and 610, the state estimation of the shuttle 100 or the LHD 110 accounts for process noise corrected using a correction factor, wherein the correction factor corresponds to a numerical value configured to update the current state. In an example, while determining updated predicted state of the shuttle 100 in X-axis direction, the at least one processor is configured to use the correction factor to neutralize the measurement noise and process noise and update the current state accurately. In an example embodiment, the updated predicted state may be denoted as Xₖ=X′ₖ+Kₖ(Zₖ−HₖX′ₖ), wherein Xₖ relates to the updated predicted state of the shuttle 100 in the X-axis direction, X′ₖ relates to the predicted state of the shuttle 100 in the X-axis direction and the correction factor denoted as—Kₖ(Zₖ−Hₖ X′ₖ) may be used to correct the process noise. The correction factor may be dependent on priori error covariance matrix having Kalman Gain matrix (Kₖ) and the measurement transformation matrix (Hₖ) as shown in equation 2 of FIG. 3C). In another example, similarly, while determining updated predicted state of the LHD 110 in Y-axis direction, the at least one processor is configured to use the correction factor to neutralize the measurement noise and process noise and update the current state accurately as discussed at the operation 608 and 610.

At operation 612, the at least one processor 502 may be configured to collect new observation Zₖ. In an example embodiment, the new observation may be one or more factors related to the correction factor as described in the operation 508 and the operation 510. In an example embodiment, the new observation may be used in the correction factor as residual of the predicted current state and the updated predicted state of the shuttle 100. Based on the new information, the at least one processor 502 may be configured to accurately determine the updated predicted state, without the process noise.

At operation 614, the at least one processor 502 may be configured to compare the updated predicted state to the desired shuttle state and control operation of the at least one drive motor to propel the shuttle 100 to the desired shuttle state, wherein, the updated predicted state becomes the state data from the immediately preceding time step for an immediately succeeding time step. In some embodiments, the at least one processor 502 may be configured to compare the updated predicted state to a desired LHD state and control operation of the first LHD motor 202 and the second LHD motor to deploy the first LHD arm 112 and the second LHD arm 114 according to the desired LHD state in Y-axis direction.

In an example embodiment, the at least one processor 502 may be configured to propel the shuttle 100 to the desired shuttle state in the X-axis direction, when the updated predicted state and predicted state are co-relatable.

In another example embodiment, the at least one processor 502 may be configured to deploy the first LHD arm 112 and the second LHD arm 114, according to the desired LHD state in Y-axis direction, when the difference between updated predicted state and predicted state may be less than or equal to the predetermined threshold value. In another example embodiment, when the difference between updated predicted state and predicted state may exceed the predetermined threshold value, the at least one processor 502 is further configured to control the first LHD motor 202 and the second LHD motor to retract back the LHD into the stowed state (as shown in FIGS. 1 and 2). In yet another example embodiment, the stowed state may correspond to home state for the LHD 110.

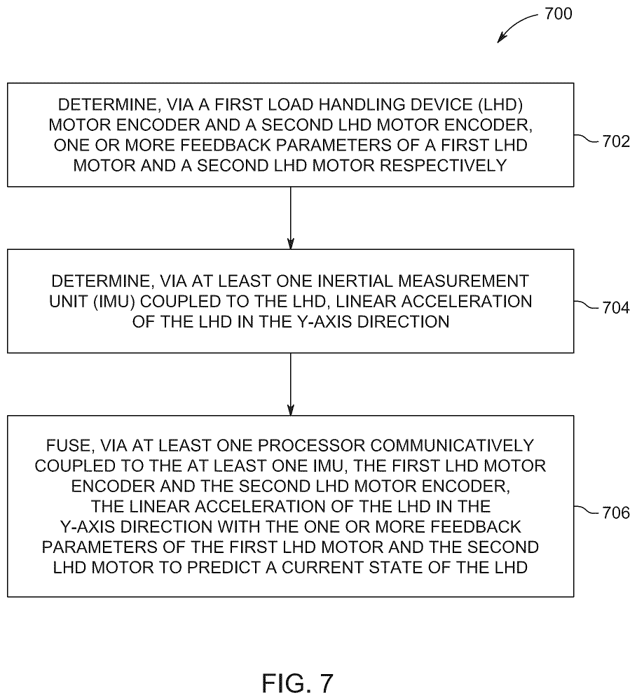

FIG. 7 illustrates a flowchart showing a method 700 in accordance with an example embodiment of the present disclosure. FIG. 7 is described in conjunction with FIGS. 1-6.

In some embodiments, the shuttle 100 may comprise the at least one drive motor encoder 104. The at least one drive motor encoder 104 may be configured to detect rotation of the at least one drive motor to propel the shuttle 100 in the X-axis direction, along the track. In an example embodiment, when the shuttle 100 may move along the track, the plurality of wheels rotate due to rotation of the axle. The rotation of the axle may be caused by the at least one drive motor and the at least one drive motor encoder 104 may detect the rotation of the at least one drive motor by determining state of the axle. In some embodiments, based on the rotation of the at least one drive motor, the at least one drive motor encoder 104 may determine state of the shuttle 100 on the track in X-axis direction.

At operation 702, the at least one processor 502 may be configured to determine one or more feedback parameters of the first LHD motor 202 and the second LHD motor respectively via the first LHD motor encoder and the second LHD motor encoder. In an example embodiment, the LHD 110 may further comprise the first IMU 106 mounted on the first LHD arm 112 and a second IMU 108 mounted on the second LHD arm 114. The first LHD motor encoder 200 and the second LHD motor encoder 500 may be configured to determine rotation of the LHD motor when the first LHD arm 112 and the second LHD arm 114 retracts back and forth towards the Y-axis direction. The at least one IMU, may determine linear acceleration of the second LHD arm.

At operation 704, the at least one processor 502 may be configured to determine linear acceleration of the LHD in the Y-axis direction, using the at least one IMU. In some embodiments, the at least one IMU may be configured to determine linear acceleration of the shuttle 100 in the X-axis direction and angular acceleration and linear acceleration of the LHD 110. In some embodiments, the at least one IMU may comprise at least one of a mono-axial accelerometer, a tri-axial accelerometer, a magnetometer, or a gyroscope.

At operation 706, the at least one processor 502 may be configured to fuse the linear acceleration of the LHD in the Y-axis direction with the one or more feedback parameters of the first LHD motor 202 and the second LHD motor to predict a current state of the LHD 110. In an example embodiment, the at least one IMU may integrate the mono-axial accelerometer, tri-axial accelerometer and gyroscope to determine linear acceleration of the shuttle 100 accurately. In some embodiments, the at least one IMU may further comprise a magnetometer. In an example embodiment, the magnetometer may be integrated with the mono-axial accelerometer, tri-axial accelerometer and gyroscope wherein the shuttle 100 may be configured to move along the track including turns and changes in direction of the shuttle 100.

In some embodiments, the at least one drive motor encoder 104, the at least one IMU, the first LHD motor encoder 200, and the second LHD motor encoder 500 may be coupled to the at least one processor 502. In an example embodiment, the at least one IMU, the at least one drive motor encoder 104, at least one IMU, the first LHD motor encoder 200 and the second LHD motor encoder 500 may be configured to generate a measurement data corresponding to a predicted current state of the shuttle 100 and the LHD 110. In an example embodiment the measurement data may correspond to the linear acceleration of the shuttle 100 and the LHD 110, and rotation of the at least one drive motor, the first LHD motor 202 and the second LHD motor.

In an example embodiment, the at least one processor 502 is further configured to predict the current state of the shuttle 100 using one or more kinematic equations. In an example embodiment, the kinematic equations may employ mathematical formulas that relate to the shuttle 100 motion without considering the forces causing that motion. The kinematic equations may account for variables like initial state, velocity, acceleration and time. By continuously updating these calculations based on the measurement data from the at least one IMU and the at least one drive motor encoder 104, the at least one processor 502 may determine the updated predicted state which may be a correct predicted state.

In some embodiments, the at least one processor may be configured to predict a current state of the LHD 110 along the Y-axis based on state data from an immediately preceding time step. The at least one processor may further sample the measurement data from at least one IMU, the at least one drive motor encoder 104, the first LHD motor encoder 200 and the second LHD motor encoder (not shown) to determine an updated predicted state of the LHD 110. The at least one processor may also compare the updated predicted state to a desired LHD 110 state. The at least one processor may further control operation of the first LHD motor 202 and the second LHD motor (not shown) to deploy the LHD arms (not shown) according to the desired LHD 110 state in Y-axis direction. In some embodiments, the updated prediction state may become the position data (one or more feedback parameters) of the immediately preceding time step for an immediately succeeding time step.

In an example, the measurement data from the at least the first IMU 106, the, second IMU 108, the first LHD motor encoder and the second LHD motor encoder includes position and velocity of the first LHD arm and the second LHD arm. In an example, the position data from immediately preceding time step may correlate to position coordinates of the LHD 110 at the time step ‘k−1’, while a predicted current state of the LHD 110 may be determined at the time step ‘k’. Further, while determining state of the LHD 110 at the immediately succeeding time step denoted as ‘k+1’ the updated predicted state may be correlate to the position data form the preceding time step ‘k’.

Embodiments may be utilized to maneuver the ASRS (Automated Storage and Retrieval System) shuttle 100 for carrying and placing goods from one aisle of the ASRS to the another. Embodiments may be utilized to propel the shuttle 100 horizontally and vertically along the designated ASRS tracks, as well as across numerous aisles of the ASRS. Embodiments may be utilized to optimize storage density, retrieval speed and across-aisle operations in ASRS inventory management.

Many modifications and other embodiments of the disclosure set forth herein will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A load handling shuttle adapted to move forward and backward along an X-axis on a track, the shuttle comprising:
a shuttle body;
a load handling device (LHD) coupled to the shuttle body and having a first LHD arm and a second LHD arm extendable back and forth in a Y-axis direction, wherein the LHD comprising:
a first LHD motor and a second LHD motor configured to independently actuate the first LHD arm and the second LHD arm in the Y-axis direction; and
a first LHD motor encoder and a second LHD motor encoder configured to determine one or more feedback parameters of the first LHD motor and the second LHD motor respectively;
at least one inertial measurement unit (IMU) coupled to the LHD, wherein the at least one IMU is configured to determine linear acceleration of the LHD in the Y-axis direction; and
at least one processor communicatively coupled to the at least one IMU, the first LHD motor encoder and the second LHD motor encoder, wherein the at least one processor is configured to fuse the linear acceleration of the LHD in the Y-axis direction with the one or more feedback parameters of the first LHD motor and the second LHD motor to predict a current state of the LHD.

2. The shuttle of claim 1, wherein the at least one processor is further configured to:
repeatedly predict the current state of the LHD at a time step, based on the one or more feedback parameters from an immediately preceding time step to determine a predicted state estimate;
sample a measurement data from the at least one IMU, first LHD motor encoders, and the second LHD motor encoders, to determine an updated predicted state;
compare the updated predicted state to a desired LHD state; and
control operation of the first LHD motor and the second LHD motor to deploy the LHD according to the desired LHD state.

3. The shuttle of claim 1, wherein the shuttle further comprises:
a plurality of wheels mounted to the shuttle body and adapted to contact the track;
at least one drive motor to propel the shuttle along the track; and
at least one drive motor encoder configured to determine the one or more feedback parameters of the at least one drive motor.

4. The shuttle of claim 3, wherein the at least one IMU is configured to determine linear acceleration of the shuttle body in an X-axis direction.

5. The shuttle of claim 4, wherein the at least one processor is communicatively coupled to the at least one drive motor and the at least one drive motor encoder, wherein the at least one processor is configured to fuse the linear acceleration of the shuttle body in the X-axis direction with the one or more feedback parameters of the at least one drive motor to predict a current state of the shuttle body in the X-axis direction.

6. The shuttle of claim 3, wherein the at least one processor is further configured to:
repeatedly predict the current state of the shuttle body at a time step, based on the one or more feedback parameters from an immediately preceding time step to determine a predicted state estimate;
sample a measurement data from the at least one IMU, and the at least one drive motor encoder, to determine an updated predicted state;
compare the updated predicted state to a desired shuttle body state; and
control operation of the at least one drive motor to propel the shuttle body according to the desired shuttle body state.

7. The shuttle of claim 6, wherein the measurement data comprise position, velocity, and acceleration of the LHD or the shuttle body corresponding to the updated predicted state and derived from the at least one IMU, first LHD motor encoders and the second LHD motor.

8. The shuttle of claim 1, wherein the at least one IMU comprises at least one of a mono-axial accelerometer, a tri-axial accelerometer, a magnetometer, or a gyroscope.

9. The shuttle of claim 3, wherein the one or more feedback parameters comprise at least one of position, speed, and direction of the first LHD motor, the second LHD motor and the at least one drive motor derived from the first LHD motor encoder and the second LHD motor encoder from an immediately preceding time step.

10. The shuttle of claim 1, wherein the state estimation of the shuttle or the LHD accounts for process noise corrected using a correction factor, wherein the correction factor corresponds to a numerical value configured to update the current state.

11. A method to control a load handling shuttle adapted to move forward and backward along an X-axis on a track, the method comprising:
determining, via a first load handling device (LHD) motor encoder and a second LHD motor encoder, one or more feedback parameters of a first LHD motor and a second LHD motor respectively, wherein the first LHD motor and the second LHD motor are configured to independently actuate a first LHD arm and a second LHD arm of a LHD coupled to a shuttle body of a shuttle in a Y-axis direction;
determining, via at least one inertial measurement unit (IMU) coupled to the LHD, linear acceleration of the LHD in the Y-axis direction; and
fusing, via at least one processor communicatively coupled to the at least one IMU, the first LHD motor encoder and the second LHD motor encoder, the linear acceleration of the LHD in the Y-axis direction with the one or more feedback parameters of the first LHD motor and the second LHD motor to predict a current state of the LHD.

12. The method of claim 11, further comprising:
predicting, via the at least one processor, repeatedly the current state of the LHD at a time step, based on the one or more feedback parameters from an immediately preceding time step to determine a predicted state estimate;
sampling, via the at least one processor, a measurement data from the at least one IMU, first LHD motor encoder, and the second LHD motor encoder, to determine an updated predicted state;
comparing, via the at least one processor, the predicted current state using a measurement data from the at least one IMU, first LHD motor encoders, and the second LHD motor encoders, to determine an updated predicted state; and
controlling, via the at least one processor, operation of the first LHD motor and the second LHD motor to deploy the LHD according to a desired LHD state.

13. The method of claim 11, wherein the shuttle further comprises:
a plurality of wheels mounted to the shuttle body and adapted to contact the track;
at least one drive motor to propel the shuttle along the track; and
at least one drive motor encoder configured to determine the one or more feedback parameters of the at least one drive motor.

14. The method of claim 13, wherein the at least one IMU is configured to determine linear acceleration of the shuttle body in an X-axis direction.

15. The method of claim 14 further comprises integrating, via the at least one processor communicatively coupled to the at least one drive motor and the at least one drive motor encoder, the linear acceleration of the shuttle body in the X-axis direction with the one or more feedback parameters of the at least one drive motor to predict a current state of the shuttle body in the X-axis direction.

16. The method of claim 13 further comprises:
predicting, via the at least one processor, repeatedly the current state of the shuttle body at a time step, based on the one or more feedback parameters from an immediately preceding time step to determine a predicted state estimate;
sample a measurement data from the at least one IMU, and the at least one drive motor encoder, to determine an updated predicted state;
comparing, via the at least one processor, the updated predicted state to a desired shuttle body state; and
controlling, via the at least one processor, operation of the at least one drive motor to propel the shuttle body according to the desired shuttle body state.

17. The method of claim 16, wherein the measurement data comprise position, velocity, and acceleration of the LHD or the shuttle body corresponding to the updated predicted state and derived from the at least one IMU, first LHD motor encoders and the second LHD motor.

18. The method of claim 11, wherein the at least one IMU comprises at least one of a mono-axial accelerometer, a tri-axial accelerometer, a magnetometer, or a gyroscope.

19. The method of claim 13, wherein the one or more feedback parameters comprise at least one of position, speed, and direction of the first LHD motor, the second LHD motor and the at least one drive motor derived from the first LHD motor encoder and the second LHD motor encoder from an immediately preceding time step.

20. The shuttle of claim 1, wherein the state estimation of the shuttle or the LHD accounts for process noise corrected using a correction factor, wherein the correction factor corresponds to a numerical value configured to update the current state.
